(19) United States
(12) Patent Application Publication
(10) Pub. No.: US 2012/0310609 A1
(43) Pub. Date: Dec. 6, 2012

(54) METHOD FOR CONTROLLING IMPEDANCE

(75) Inventors: HSIN-KUAN WU, Tu-Cheng (TW); HOU-YUAN CHOU, Tu-Cheng (TW)

(73) Assignee: HON HAI PRECISION INDUSTRY CO., LTD., Tu-Cheng (TW)

(21) Appl. No.: 13/193,627

(22) Filed: Jul. 29, 2011

(30) Foreign Application Priority Data
May 31, 2011 (TW) 100118941

(51) Int. Cl. G06F 17/10

(52) U.S. Cl. 703/2

(57) ABSTRACT

A method for controlling impedance of a multi-layer PCB includes establishing a geometric model using simulation software according to a structure of the multi-layer PCB. A first variable (S) and a second variable (W) are respectively defined in the simulation software. The variable S is set equal to a first desired value. An impedance (R) of the transmission line is set equal to a second desired value. The variable W is set to a value according to a relationship between R, S, and W.

### BACKGROUND

1. Technical Field

The present disclosure relates to methods for controlling impedance, and particularly to a method for controlling impedance of a multi-layer printed circuit board (PCB).

2. Description of Related Art

A top layer of multi-layer PCBs may include at least one transmission line that is used for transmitting high speed signals. However, impedance of the transmission line will be greatest near an edge of the multi-layer PCB, and will affect integrity of signal transmission, which may lead to signal distortion. Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an embodiment of a multi-layer PCB.

FIG. 2 is a flowchart of a method for controlling impedance of the multi-layer PCB shown in FIG. 1.

FIG. 3 is a diagram showing a relationship between a width of the transmission line and a distance from a center point where a line bisects the transmission line to an edge of the multi-layer PCB shown in FIG. 1, when an impedance of the transmission line is equal to a first desired value.

FIG. 4 is similar to FIG. 3, but the impedance of the transmission line is equal to a second desired value.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

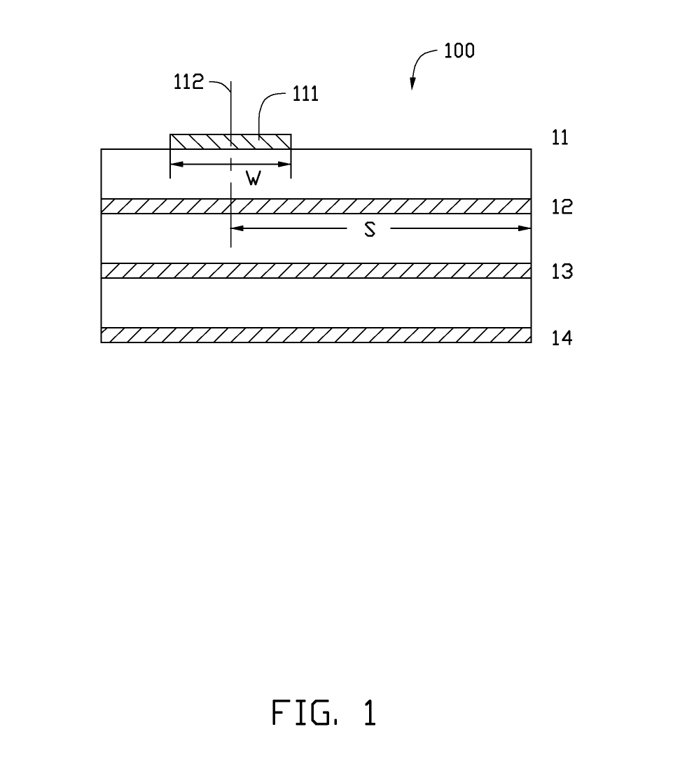

FIG. 1 is a schematic view of an embodiment of a multi-layer PCB, for example, a four-layer PCB 100. The PCB 100 includes first to fourth layers 11, 12, 13, and 14. Dielectric materials (not label) are respectively sandwiched between adjacent first to fourth layers 11, 12, 13, and 14. The first layer 11 and the fourth layer 14 are both signal layers. The second layer 12 is a power layer. The third layer 13 is a ground layer. In one embodiment, the thickness of the first to fourth layers 11, 12, 13, and 14 are respectively about 1.9 mils, 1.2 mils, 1.2 mils, and 1.9 mils. A transmission line 111 is set on the first layer 11.

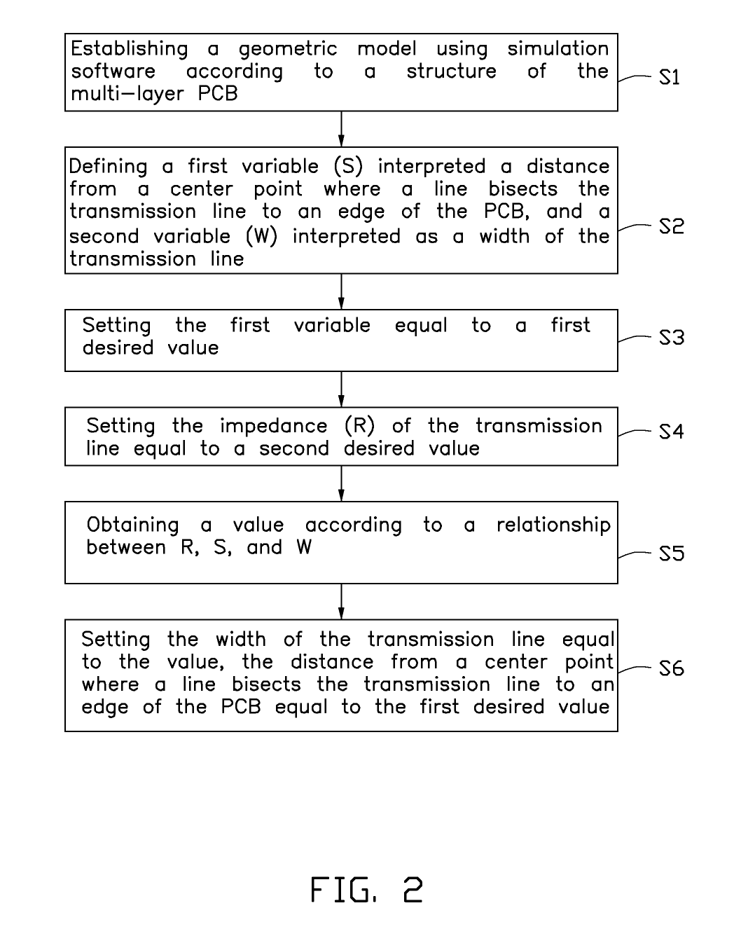

FIG. 2 is a flowchart of a method for controlling impedance of the PCB 100. The method is used to adjust a width of the transmission line 111 according to a distance, thereby making the impedance of the transmission line 111 equal to a desired impedance value, such as 32 ohms, 50 ohms, etc. The transmission line 111 can be a single trace, a differential trace, or a pad of an electronic component. Depending on the embodiment, certain of the steps described may be removed, others many be added, and the sequence of the steps may be altered. It is also to be understood that the description and the claims drawn to a method may include some indication in reference to certain steps. However, the indication used is only to be viewed for identification purposes and not as a suggestion as to an order for the steps.

In step 1, a geometric model is established using simulation software according to a structure of the four-layer PCB 100. The simulation software can be a quasi three-dimensional (Q3D) modeling software.

In step 2, a first variable S and a second variable W are respectively defined in the simulation software. The first variable S represents a distance from a center point where a line 112 bisects the transmission line 111 to an edge of the PCB 100. The second variable W represents a width of the transmission line 111 in mils.

In step 3, the first variable S is set equal to a first desired value as set by a user. For example, if the user needs the distance from a center point where the line 112 bisects the transmission line 111 to the edge of the PCB 100 to be 2 mils, the first variable S is set equal to 2 mils.

In step 4, the impedance R of the transmission line 111 is set equal to a second desired value as set by the user. For example, if the user needs the impedance of the transmission line 111 to be 50 ohms, the impedance R is set to 50 ohms.

In step 5, a value W1 is obtained according to a relationship between R, S, and W which is previously determined by testing.

In step 6, the width of the transmission line 111 is set equal to W1, and a distance from a center point where the line 112 bisects the transmission 111 to the edge of the PCB 100 is set equal to the first desired value. In this way, the impedance of the transmission line 111 is equal the second desired value.

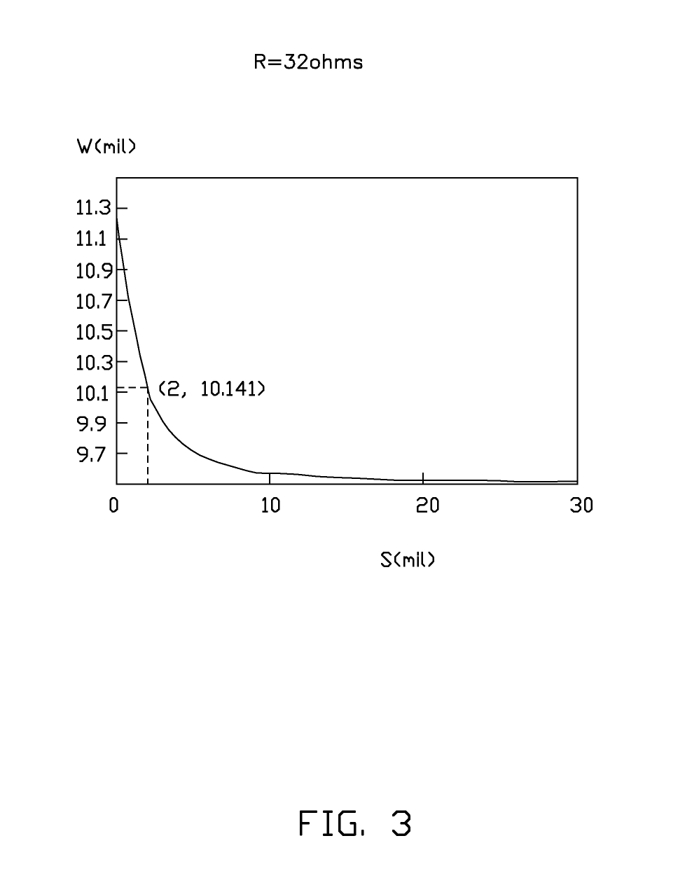

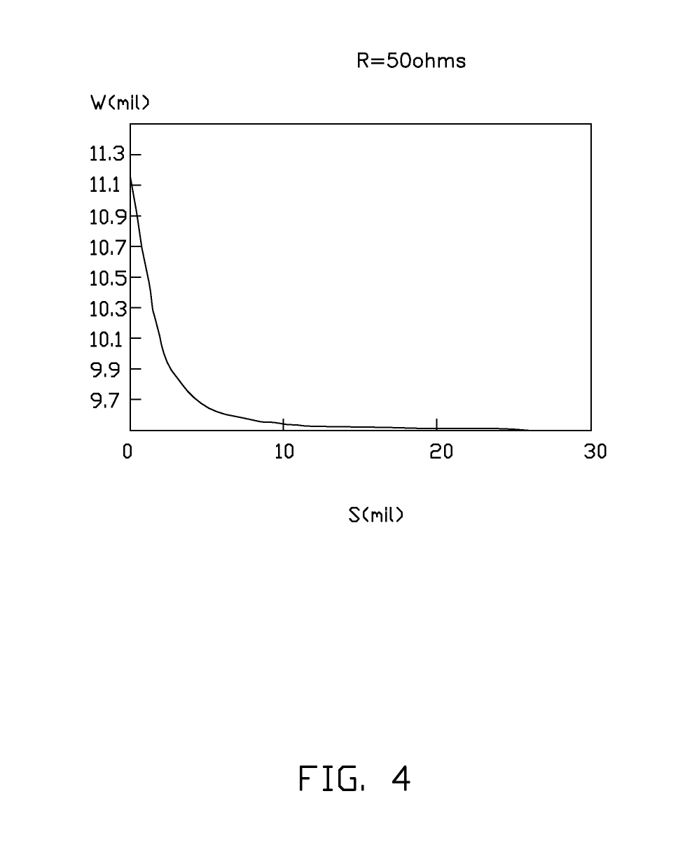

FIG. 3 and FIG. 4 show the relationship between S and W according to testing, when the desired impedance of the transmission line 111 is 32 ohms (FIG. 3), or 50 ohms (FIG. 4). For example, if the user requires R equal to 32 ohms, and S equal to 2 mils, then from FIG. 3 we see that W must be set equal to 10.141 mils.

The method for controlling impedance can adjust the width of the transmission line 111 according to different distances from a center point where a line would bisect the transmission line 111 to an edge of the PCB 100, thereby making the impedance of the transmission line 111 equal to a desired impedance value. The method for controlling impedance can improve quality of signal transmission of the transmission line 111 effectively, and need not change the structure of the multi-layer PCB, such as adjusting a wiring structure of the multi-layer PCB, or defining vias in the multi-layer PCB.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A method for controlling impedance of a multi-layer printed circuit board (PCB), comprising:
establishing a geometric model using simulation software according to a structure of the multi-layer PCB;
defining a first variable (S) and a second variable (W) in the simulation software, wherein S represents a distance from a center point where a line bisects a transmission line of the multi-layer PCB to an edge of the multi-layer PCB, and W represents a width of the transmission line;
setting S equal to a first desired value;
setting an impedance (R) of the transmission line equal to a second desired value;
obtaining a value according to a relationship between R, S, and W; and
setting the width of the transmission line equal to the value, and the distance from a center point where a line bisects the transmission line to the edge of the multi-layer PCB equal to the first desired value.

2. The method of claim 1, wherein the simulation software is a quasi three-dimensional (Q3D) modeling software.

3. The method of claim 1, wherein the transmission line is a single trace, a differential trace, or a pad of an electronic component.

4. The method of claim 1, wherein the multi-layer PCB is a four-layer PCB, the four-layer PCB including first to fourth layers, the transmission line is set on the first layer.

5. The method of claim 4, wherein the first layer and the fourth layer are both signal layers, the second layer is a power layer, the third layer is a ground layer.

6. The method of claim 4, wherein the thickness of the first to fourth layers are respectively about 1.9 mils, 1.2 mils, 1.2 mils, and 1.9 mils.
